(19) United States
(12) Patent Application Publication
(10) Pub. No.: US 2021/0261864 A1
(43) Pub. Date: Aug. 26, 2021

(54) MATERIAL FOR LIQUID-CRYSTAL DEVICE, AND LIQUID-CRYSTAL DEVICE

(71) Applicants: JNC CORPORATION, Tokyo (JP); JNC PETROCHEMICAL CORPORATION, Tokyo (JP)

(72) Inventors: Mayumi TANABE, Chiba (JP); Shinichi YAMAMOTO, Chiba (JP); Hiroaki FUJITA, Chiba (JP)

(73) Assignees: JNC CORPORATION, Tokyo (JP); JNC PETROCHEMICAL CORPORATION, Tokyo (JP)

(21) Appl. No.: 16/322,485

(22) PCT Filed: Aug. 4, 2017
(86) PCT No.: PCT/JP2017/028413

§ 371 Date: Feb. 1, 2019

(30) Foreign Application Priority Data
Aug. 4, 2016 (JP) 2016-153864
Nov. 7, 2016 (JP) 2016-217309

(51) Int. Cl. C09K 19/54; C09K 19/30; C09K 19/34; C09K 19/58; G02F 1/1343; G02F 1/137; G02F 1/1341

(52) U.S. Cl. CPC C09K 19/542; C09K 19/3066; C09K 19/3402; C09K 2019/0466; G02F 1/134309; G02F 1/137; G02F 1/1341; C09K 19/586

(57) ABSTRACT

A material for liquid-crystal devices which have a low operating voltage in a normal mode or a reverse mode and high-contrast properties. The material for liquid-crystal devices is characterized by containing at least one polymerizable compound and at least one compound selected from among compounds represented by general formulae (K1) and (K2) and by comprising a liquid-crystal material.

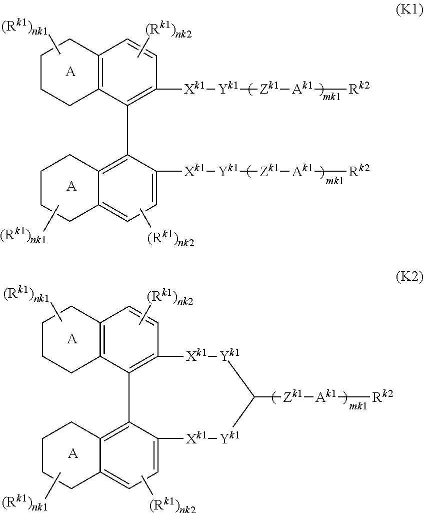

### TECHNICAL FIELD

The present invention relates to a liquid crystal device constituting a light control window component including a liquid crystal composition without using a polarizing plate.

More specifically, the present invention relates to a liquid crystal device which can electrically control blockage and transmission of external light or the field of view, and particularly to a liquid crystal device that is used for a light control window for blocking or transmitting external light or the field of view such as building windows and show windows, indoor partitions, and vehicle sunroofs and rear windows.

### BACKGROUND ART

As a technology through which driving at a low voltage, which is an important characteristic required for realizing practical applications for a light scattering type liquid crystal display device, is possible, Patent Literature 1 to 3 disclose a light control layer using a photopolymerizable composition and a chiral nematic liquid crystal composition including a chiral material. A light control layer is produced by photopolymerizing a photopolymerizable monomer included in a chiral nematic composition in the presence of a polymerization initiator and used for a liquid crystal device that is driven at a low voltage.

### CITATION LIST

### Patent Literature

[Patent Literature 1]

Japanese Patent No. 3401680

[Patent Literature 2]

Japanese Patent No. 3383921

[Patent Literature 3]

Japanese Patent No. 3401681

### SUMMARY OF INVENTION

### Technical Problem

However, although liquid crystal devices are able to be driven for a light control window, they have not had a high contrast that is important in practical applications for a liquid crystal device for display.

An object of the present invention to be achieved is to provide a material for a liquid crystal device having a low driving voltage and high contrast characteristics as a light control window.

### Solution to Problem

In order to achieve the above object, the inventors examined a liquid crystal material in a light control layer using a chiral agent having high solubility in a liquid crystal material and a high helical twisting power (HTP). As a result, it was found that, when a predetermined configuration is used, it is possible to produce a liquid crystal device having a low driving voltage and high contrast as a light control window, and thereby the present invention was completed.

In order to solve the above problems, the present invention provides items including the following [1].

[1] A material for a liquid crystal device formed of a liquid crystal material including at least one polymerizable compound and at least one compound selected from among compounds represented by General Formulae (K1) and (K2).

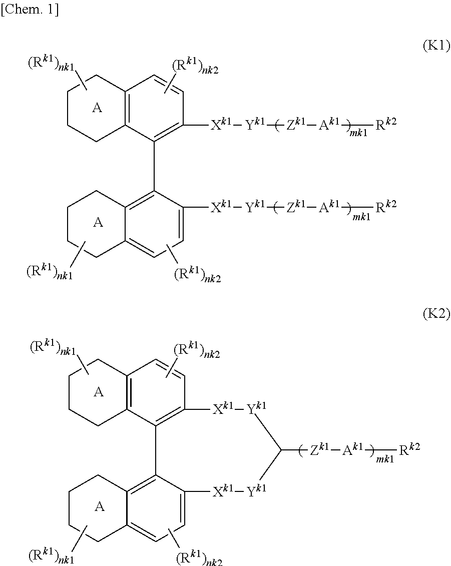

(in Formulae (K1) and (K2),

R^{k1} is independently a hydrogen atom, a halogen atom, a cyano group, —SF₅, or an alkyl group having 1 to 5 carbon atoms, at least one —CH₂— in the alkyl group is optionally replaced with —O—, —COO— or —OCO—, at least one —CH₂—CH₂— is optionally replaced with —CH═CH— or —C≡C—, and two consecutive —CH₂— are not replaced with —O—, and at least one hydrogen atom in the alkyl group is optionally replaced with a halogen atom;

R^{k2} is independently a hydrogen atom, a halogen atom, a cyano group, —SF₅, or an alkyl group having 1 to 20 carbon atoms, at least one —CH₂— in the alkyl group is optionally replaced with —O—, —COO— or —OCO—, at least one —CH₂—CH₂— is optionally replaced with —CH═CH— or —C≡C—, and two consecutive —CH₂— are not replaced with —O—, and at least one hydrogen atom in the alkyl group is optionally replaced with a halogen atom;

the ring A is a ring that is linked to a phenylene ring to form a polycyclic structure and is independently 1,2-phenylene or 1,2-cyclohexylene;

the ring A^{k1} has a ring structure having two binding sites is independently 1,4-phenylene, 1,4-cyclohexylene, 1,3-dioxane-2,5-diyl, tetrahydropyran-2,5-diyl, tetrahydropyran-3,5-diyl, pyrimidine-2,5-diyl, pyridine-2,5-diyl, or 1,4-bicyclo-(2,2,2)-octylene, and in these rings, at least one hydrogen atom is optionally replaced with a halogen atom;

X^{k1} is independently a single bond, —O—, —CO—, —COO—, —OCO—, —OCH₂—, —CH₂O—, —CF₂O—, —OCF₂—, —CH═CH—, —CF₂CF₂—, —CF═CF—, or —C≡C—;

Y^{k1} is independently a single bond or —(CH₂)ₙ—, and n is an integer of 1 to 20;

Z^{k1} is independently a single bond or an alkylene group having 1 to 10 carbon atoms, at least one —CH₂— in the alkylene group is optionally replaced with —O—, —COO— or —OCO—, at least one —CH₂—CH₂— is optionally replaced with —CH═CH—, —CF═CF— or —C≡C—, and at least one hydrogen atom in the alkylene group is optionally replaced with a halogen atom (provided that those having —O—O— in Z^{k1} are excluded);

mk1 is independently an integer of 2 to 4; and; nk1 and nk2 are independently an integer of 0 to 2)

In addition, the present invention also includes the following [2] to [11]. [2] The material for a liquid crystal device according to [1],

wherein the compounds represented by General Formulae (K1) and (K2) is Formulae (K101) to (K106) or (K201) to (K206).

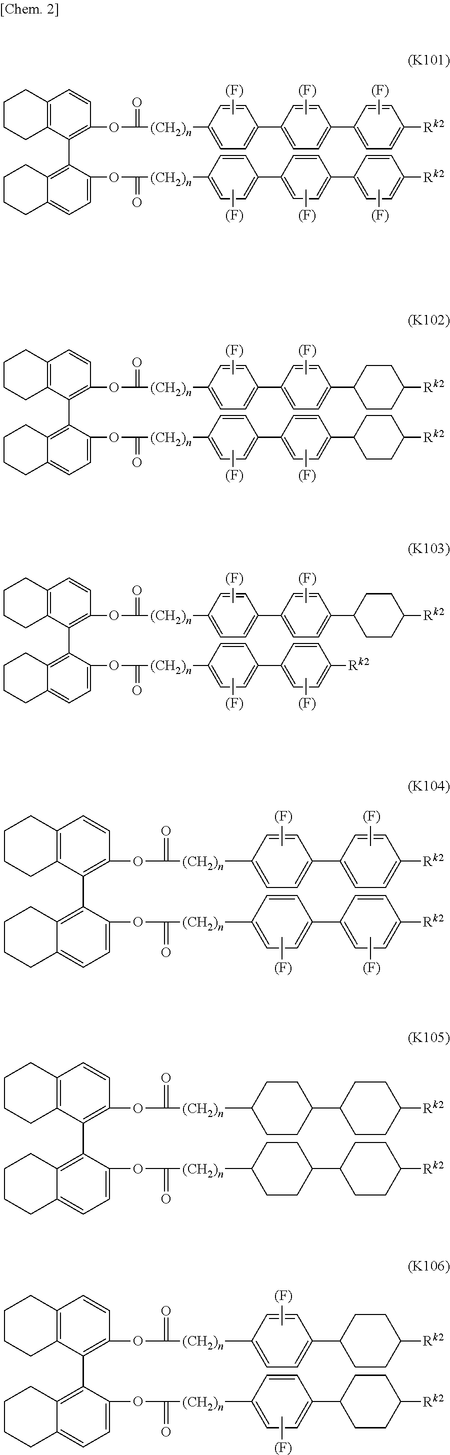

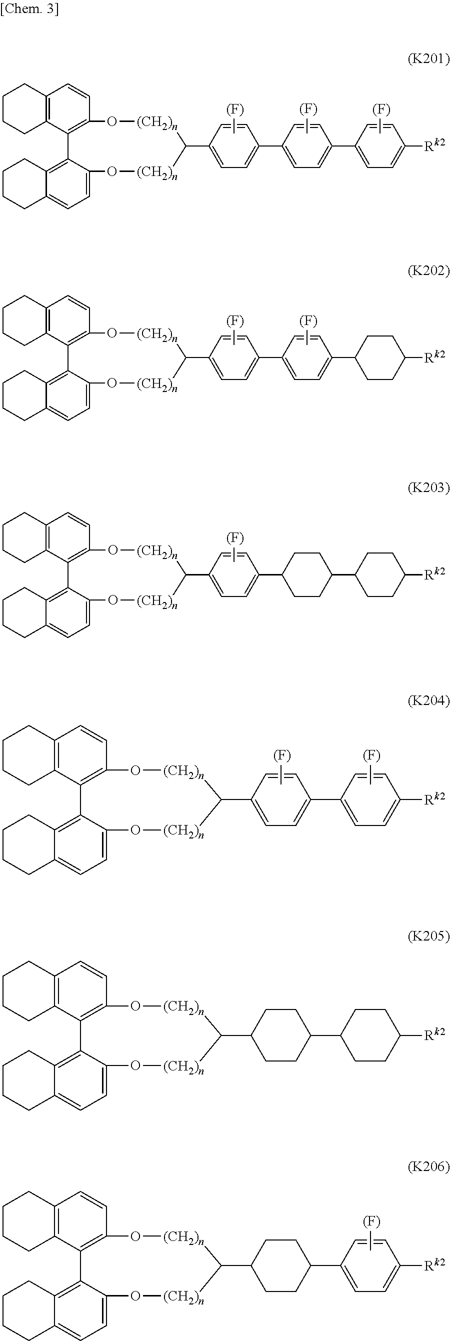

(in Formulae (K101) to (K106) and Formulae (K201) to (K206),

R^{k2} is independently a hydrogen atom, a halogen atom, a cyano group, —SF₅, or an alkyl group having 1 to 20 carbon atoms,

n is independently an integer of 1 to 20,

provided that Partial Structural Formula (X1) and Formula (X2):

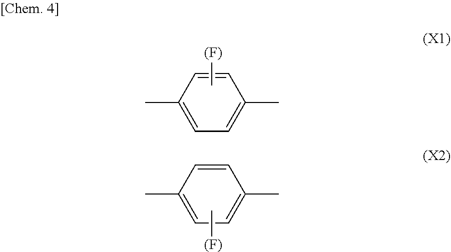

are independently 1,4-phenylene in which any hydrogen atom is optionally replaced with one or two fluorine atoms)

[3] The material for a liquid crystal device according to [2],

wherein, in the compounds represented by Formulae (K101) to (K106), n is 0.

[4] The material for a liquid crystal device according to [2],

wherein, in the compounds represented by Formulae (K201) to (K206), n is 1.

[5] The material for a liquid crystal device according to any one of [1] to [4],

wherein the liquid crystal material further includes a compound represented by Formula (1-A) or (1-B).

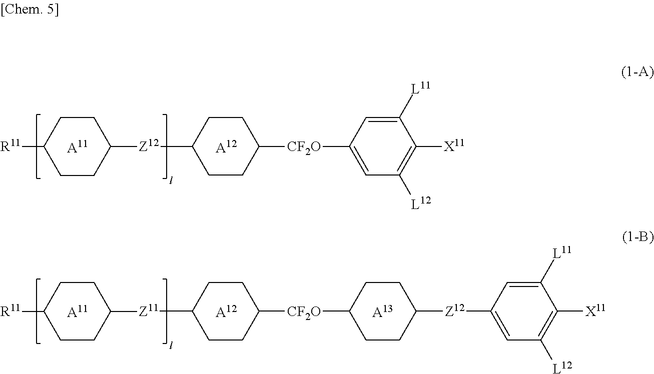

(in Formula (1-A) or (1-B),

R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,

the ring A¹¹, the ring A¹² and the ring A¹³ are independently 1,4-phenylene or 1,4-cyclohexylene, and at least one hydrogen atom in these rings is optionally replaced with a halogen atom,

Z¹¹ and Z¹² are independently a single bond or an alkylene group having 1 to 4 carbon atoms, at least one —CH₂— in the alkylene group is optionally replaced with —O—, —S—, —COO—, —OCO—, —CH═CH—, —CF═CF— or —C≡C—, and at least one hydrogen atom in the alkylene group is optionally replaced with a halogen atom,

L¹¹ and L¹² are independently a hydrogen atom or a halogen atom,

X¹¹ is a halogen atom, —C≡N, —N═C═S, —CF₃ or —OCF₃, and 1 is 0, 1 or 2.)

[6] The material for a liquid crystal device according to [1],

wherein the liquid crystal material further includes a compound represented by Formula (1-C).

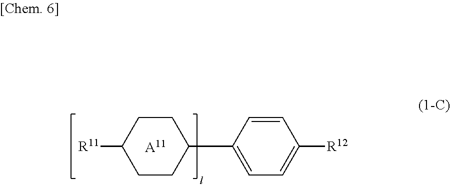

(in Formula (1-C),

R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,

the ring A¹¹ is independently 1,4-phenylene or 1,4-cyclohexylene, and at least one hydrogen atom in these rings is optionally replaced with a halogen atom, and

l is 1, 2 or 3.)

[7] The material for a liquid crystal device according to any one of [1] to [6],

wherein the liquid crystal material further includes a compound represented by General Formula (1-E).

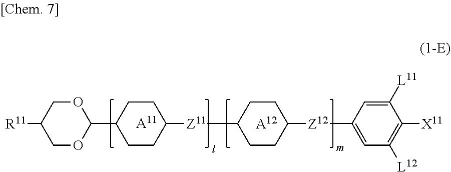

(in General Formula (1-E), R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,

the ring A¹¹ and the ring A¹² are independently 1,4-phenylene or 1,4-cyclohexylene, and any hydrogen atom in these rings is optionally replaced with a halogen atom,

Z¹¹ and Z¹² are independently a single bond or an alkylene group having 1 to 4 carbon atoms (any hydrogen atom in the alkylene group is optionally replaced with a halogen atom), and at least one —CH₂— in the alkylene group is optionally replaced with —O—, —S—, —COO—, —OCO—, —CF₂O—, —OCF₂—, —CH═CH—, —CF═CF— or —C≡C—,

L¹¹ and L¹² are independently a hydrogen atom or a halogen atom,

X¹¹ is a halogen atom, —C≡N, —N═C═S, —SF₅, —CF₃ or —OCF₃, and

l and m are independently 0 or 1)

[8] A liquid crystal device including:

two substrates each having an electrode layer and at least one of which is transparent; and

a light control layer that is supported between the substrates,

wherein the light control layer includes a transparent material formed of a polymer of the polymerizable compound and the liquid crystal material having a chiral nematic phase according to any one of [1] to [7].

[9] The liquid crystal device according to [8],

wherein a content of the transparent material in the light control layer is in a range of 0.1 to 60 weight %.

[10] A light control method including:

applying a voltage to a light control layer including a transparent material formed of a polymer of the polymerizable compound and a liquid crystal material having a chiral nematic phase according to any one of [1] to [7], and driving the light control layer.

[11] A light control method including:

providing two substrates each having an electrode layer and at least one of which is transparent, and a light control layer that is supported between the substrates, and

incorporating a liquid crystal material including a transparent material formed of a polymer of the polymerizable compound and having a chiral nematic phase according to any one of [1] to [7] into the light control layer, and applying a voltage between electrodes and driving the light control layer.

[12] A method of producing a liquid crystal device comprising:

interposing the material for a liquid crystal device according to any one of [1] to [7] between two substrates each having an electrode layer and at least one of which is transparent;

emitting ultraviolet rays or heating;

polymerizing the polymerizable compound; and

forming a light control layer formed of a transparent material and a liquid crystal material.

### Advantageous Effects of Invention

A liquid crystal device of the present invention includes at least one compound selected from among compounds represented by General Formulae (K1) and (K2) as a liquid crystal material. A light control window using such a liquid crystal device has low voltage driving properties and has high contrast. In the liquid crystal device of the present invention, the change in light scattering is large between when a voltage is applied and when no voltage is applied.

In addition, a light control window constituted of the liquid crystal device of the present invention also has a characteristic that contrast characteristics do not change in a wide temperature range. In the light control window of the present invention, high contrast characteristics are obtained even if a driving voltage is low, and a high driving voltage source is not necessary.

Such a liquid crystal device can electrically control blockage or transmission of external light or the field of view, and can be used for various applications such as light control glass for blocking and transmission of external light or the field of view such as building windows and show windows, indoor partitions, vehicle sunroofs, and rear windows, a display device of a computer terminal, a projection display device, and the like.

### BRIEF DESCRIPTION OF DRAWINGS

FIG. 1 is a cross-sectional view showing an example of a structure of a liquid crystal device of the present invention.

FIG. 2 is a cross-sectional view showing an example of the structure of the liquid crystal device of the present invention.

FIG. 3 is a cross-sectional view showing an example of the structure of the liquid crystal device of the present invention.

FIG. 4 is a cross-sectional view showing an example of the structure of the liquid crystal device of the present invention.

FIG. 5 shows curves of an applied voltage and a transmittance between electrodes of a polymer/liquid crystal composite material PDLC-A evaluated in examples.

### DESCRIPTION OF EMBODIMENTS

While embodiments of the present invention will be described below, the present invention is not limited to these descriptions.

A material for a liquid crystal device of the present invention includes a liquid crystal material including at least one polymerizable compound and at least one compound selected from among compounds represented by General Formulae (K1) and (K2).

In the present invention, regarding a compound, when a structure in which a structure of a ring in a chemical structural formula is intersected by functional groups in the chemical structural formula having a valency is shown, both a compound in which the functional groups are not replaced with a hydrogen atom in the ring and a compound in which the functional groups are independently replaced with a hydrogen atom in the ring are included.

In the present invention, regarding a compound, when a ring structure having two bonds in a chemical structural formula is shown, a compound in which one bond and the other bond can be interchanged is also included.

The compounds represented by General Formulae (K1) and (K2) are preferably a chiral compound. Since these compounds have a high HTP and high compatibility, it is possible to adjust a pitch to 0.5 μm or less. Since more effective light scattering properties are thus obtained, it is possible to provide a liquid crystal device with high contrast.

As the compounds represented by General Formulae (K1) and (K2), those of Formulae (K101) to (K106) and (K201) to (K206) have high solubility in other liquid crystal materials, and thus an addition amount thereof can be increased and it is possible to adjust a pitch in a wide range. In addition, the obtainable composition can be stored for a long time at room temperature without crystals precipitating. When crystals in the composition precipitate, the quality of a product deteriorates. Therefore, a certain storage stability for the composition at room temperature is required in order to maintain the quality of a product.

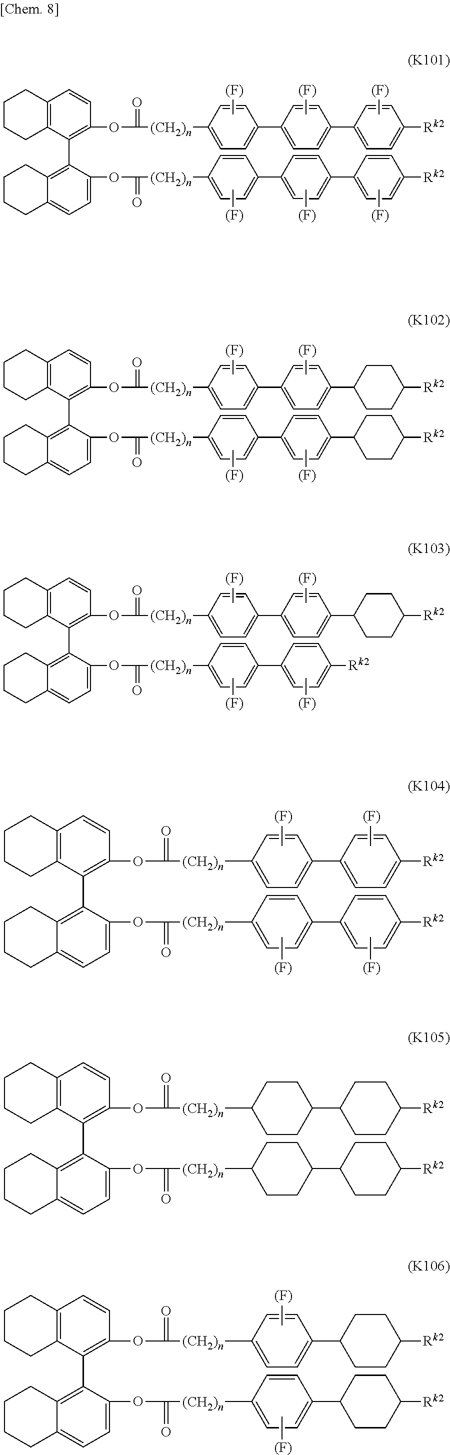

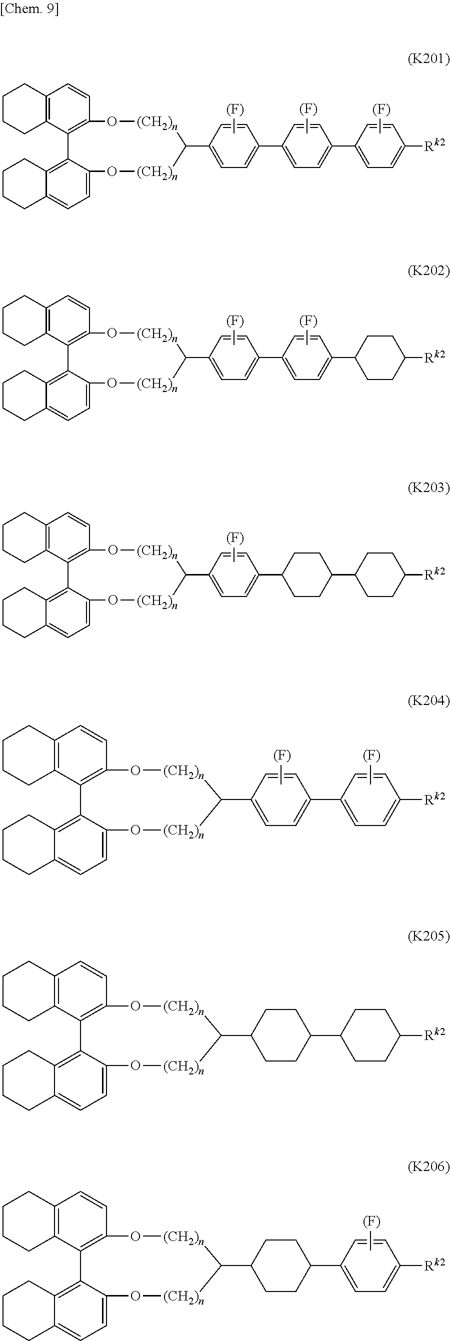

(in Formulae (K101) to (K106) and Formulae (K201) to (K206),

R^{k2} is independently a hydrogen atom, a halogen atom, a cyano group, —SF₅, or an alkyl group having 1 to 20 carbon atoms,

n is independently an integer of 1 to 20,

provided that, Partial Structural Formula (X1) and Formula (X2):

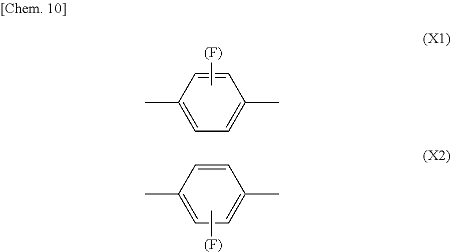

are independently 1,4-phenylene in which any hydrogen atom is optionally replaced with one or two fluorine atoms.)

In the compounds represented by Formulae (K101) to (K106), n is preferably 0 because a high HTP is then exhibited.

In addition, in the compounds represented by Formulae (K201) to (K206), n is preferably 1 because a high HTP is then exhibited and additionally the productivity is improved.

For the liquid crystal material used in the present invention, typically, a material having a chiral nematic phase after a polymerizable compound included in the material for a liquid crystal device of the present invention is polymerized is used. At least one compound selected from among the compounds represented by General Formulae (K1) and (K2) is used as the liquid crystal material. However, in addition to these compounds, generally, a material recognized as a liquid crystal material in the technical field may be additionally added and used as another liquid crystal material. As the other liquid crystal material, a material that is generally recognized as a liquid crystal material in the technical field may be used, and a compound having positive dielectric anisotropy or negative dielectric anisotropy can be used. In order to optimize the performance of the liquid crystal material used in the present invention, it is preferable to use a chiral nematic liquid crystal or a cholesteric liquid crystal in combination. In addition, a chiral compound other than the compounds of General Formulae (K1) and (K2) may be appropriately included in the liquid crystal material.

A proportion in the liquid crystal material is not particularly limited, and the compound represented by Formula (1-A) or (1-B) is preferably included in an amount of 5 weight % or more in the liquid crystal material. In addition, it is preferably included in a range of 10 to 50 weight %.

For example, as a liquid crystal material, it is preferable to further include the compound represented by Formula (1-A) or (1-B).

When the compound represented by Formula (1-A) or (1-B) is combined with the compounds of Formulae (K1) and (K2), an applied voltage for changing a scattering state to a transmitting state decreases, scattering characteristics at a low voltage become excellent and high contrast characteristics can be exhibited.

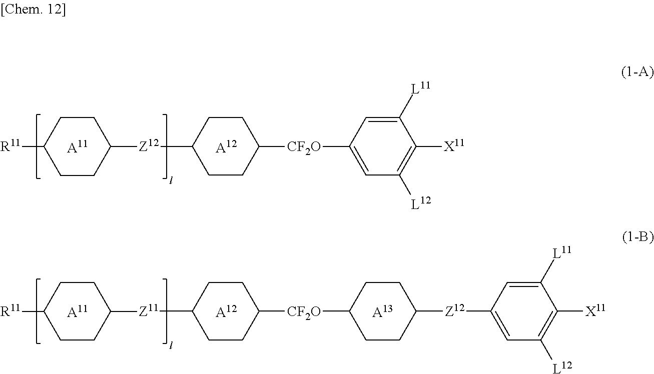

(in Formula (1-A) or (1-B),

R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,

the ring A¹¹, the ring A¹² and the ring A¹³ are independently 1,4-phenylene or 1,4-cyclohexylene, and at least one hydrogen atom in these rings is optionally replaced with a halogen atom,

Z¹¹ and Z¹² are independently a single bond or an alkylene group having 1 to 4 carbon atoms, at least one —CH₂— in the alkylene group is optionally replaced with —O—, —S—, —COO—, —OCO—, —CH═CH—, —CF═CF— or —C≡C—, and at least one hydrogen atom in the alkylene group is optionally replaced with a halogen atom

L¹¹ and L¹² are independently a hydrogen atom or a halogen atom,

X¹¹ is a halogen atom, —C≡N, —N═C═S, —CF₃ or —OCF₃, and 1 is 0, 1 or 2.)

In addition, an embodiment in which a compound represented by Formula (1-C) is further included is preferable. The compound represented by Formula (1-C) may be included together with the compound represented by Formula (1-A) or (1-B) or included in place of the compound represented by Formula (1-A) or (1-B). When the compound represented by Formula (1-C) is combined with the compounds of Formulae (K1) and (K2), it is possible to reduce the viscosity of the liquid crystal composition.

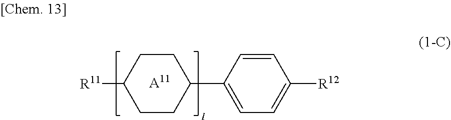

(In Formula (1-C),

R¹¹ and R¹² are a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom, the ring A¹¹ is independently 1,4-phenylene or 1,4-cyclohexylene, and at least one hydrogen atom in these rings is optionally replaced with a halogen atom, and

l is 1, 2 or 3.)

For example, as a liquid crystal material, preferably, a compound represented by General Formula (1-E) is further included.

When the compound represented by Formula (1-E) is combined with the compounds of Formulae (K1) and (K2), the liquid crystal material has high transmittance when a voltage is applied and a high contrast ratio.

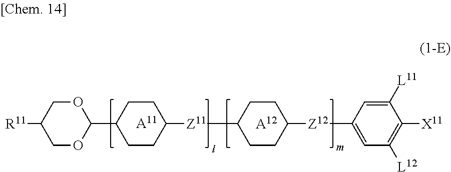

(in General Formula (1-E), R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,

the ring A¹¹ and the ring A¹² are independently 1,4-phenylene or 1,4-cyclohexylene, and any hydrogen atom in these rings is optionally replaced with a halogen atom,

Z¹¹ and Z¹² are independently a single bond or an alkylene group having 1 to 4 carbon atoms (any hydrogen atom in the alkylene group is optionally replaced with a halogen atom), and at least one —CH₂— in the alkylene group is optionally replaced with —O—, —S—, —COO—, —OCO—, —CF₂O—, —OCF₂—, —CH═CH—, —CF═CF— or —C≡C—,

L¹¹ and L¹² are independently a hydrogen atom or a halogen atom,

X¹¹ is a halogen atom, —C≡N, —N═C═S, —SF₅, —CF₃ or —OCF₃, and

l and m are independently 0 or 1.)

An embodiment in which the liquid crystal material used in the present invention has a helical pitch shorter than 0.5 μm is preferable.

An embodiment in which the liquid crystal material used in the present invention has a helical pitch longer than 0.5 μm is preferable.

The helical pitch of the liquid crystal material used in the present invention is particularly preferably in a range of 0.3 to 0.5 μm, and 0.6 to 5 μm in order to obtain sufficient contrast between opacity and transparency due to light scattering.

When the helical pitch is short, transparency due to light scattering is relatively high, and when the pitch is long, opacity due to light scattering is relatively high.

A content of the polymerizable compound included in the material for a liquid crystal device of the present invention can be adjusted according to application purposes. For example, when used as a material for forming a light control layer of a liquid crystal device to be described below, in order to obtain sufficient contrast between opacity and transparency due to light scattering, in the material for a liquid crystal device, the polymerizable compound is preferably included in a range of 0.1 to 50 weight %, more preferably included in a range of 0.1 to 40 weight %, still more preferably included in a range of 0.1 to 20 weight %, and most preferably included in a range of 0.1 to 10 weight %. When such a material for a liquid crystal device is used, a liquid crystal device having a light control layer in which a transparent material obtained from the polymerizable compound is preferably included in a range of 0.1 to 50 weight %, more preferably 0.1 to 40 weight %, still more preferably 0.1 to 20 weight %, and most preferably 0.1 to 10 weight % is obtained.

In order to control a structure of the transparent material which forms a part of a light control layer of a liquid crystal device to be described below according to purposes thereof, the polymerizable compound is preferably a polymerizable compound including at least one selected from among a polymer forming monomer and a polymer forming oligomer.

Examples of the polymer forming monomer or oligomer include a polymer forming monomer or oligomer having one polymerizable group such as an acryloyl group, for example, n-dodecyl acrylate: and

a polymer forming monomer or oligomer having two or more polymerizable groups such as an acryloyl group, for example, trimethylolpropane triacrylate, tetraethylene glycol diacrylate, 1,10-decanediol diacrylate, and polymerizable liquid crystal compounds represented by Formulae (δ) and (M-1) to be described below.

It is desirable for the light control layer of the liquid crystal device to maintain high contrast at a working temperature. In order to maintain high contrast, a phase transition temperature from a chiral nematic phase to an isotropic liquid in the liquid crystal device material is preferably higher than a working temperature of the liquid crystal device. Preferably, a raw material of the light control layer includes at least one polymerizable compound having liquid crystallinity, at least one polymerizable compound having no liquid crystallinity, or a mixture thereof.

In order to maintain high contrast at a working temperature, a content of the polymerizable compound having liquid crystallinity (polymerizable liquid crystal compound) in the raw material of the light control layer is preferably 0.1 to 30 weight %, more preferably 1 to 20 weight %, still more preferably 3 to 20 weight %, and most preferably 5 to 15 weight %. In order to maintain high contrast at a working temperature, a content of the polymerizable compound having no liquid crystallinity in the raw material of the light control layer is preferably 0.1 to 60 weight %, more preferably 10 to 60 weight %, still more preferably 20 to 60 weight %, and most preferably 30 to 60 weight %.

As the polymer forming monomer or oligomer included in the polymerizable compound, a polymer forming monomer or oligomer having two or more polymerizable groups is preferable, and a polymer forming monomer or oligomer having two or more acryloyl groups is more preferable. When such a monomer or oligomer is included in the polymerizable compound, if it is used for, for example, a liquid crystal device having a light control layer such as a light control window, it is possible to produce a material for a liquid crystal device that can be driven at a lower voltage and that has higher contrast characteristics.

Since a transparent material which forms a part of the light control layer is a polymer of a polymerizable compound, a polymerization initiator such as a thermal polymerization initiator and a photopolymerization initiator may be included in the polymerizable compound. As the polymerization initiator such as a thermal polymerization initiator and a photopolymerization initiator, commercially available polymerization initiators can be used. In addition, other additives such as a chain transfer agent, a photosensitizer, and a dye crosslinking agent may be included in the polymerizable compound.

When a voltage is applied to the light control layer including a transparent material formed of a polymer of the above polymerizable compound and a liquid crystal material having a chiral nematic phase, the light control layer is driven and thus light control can be performed.

The liquid crystal device of the present invention includes two substrates each having an electrode layer and at least one of which is transparent and a light control layer interposed between the substrates. The light control layer includes a polymer of a material for a liquid crystal device, that is, a transparent material formed of a polymer of a polymerizable compound included in the material for a liquid crystal device, and a liquid crystal material including at least one compound selected from among the compounds represented by General Formulae (K1) and (K2).

A liquid crystal display element having a blue phase fixed thereto has a double twist structure. The light control layer of the light control window of the present invention does not have a double twist structure in a working temperature range. The light control layer of the light control window of the present invention includes a liquid crystal phase domain and a domain other than the liquid crystal phase domain (hereinafter referred to as a non-liquid crystal phase domain).

The size of the liquid crystal phase domain is typically 100 nm or more. According to the size of the liquid crystal phase domain in the light control layer and/or the disposition of the liquid crystal phase domain, the light control window can block and transmit light. When a difference in refractive index between the liquid crystal phase domain and the non-liquid crystal phase domain increases, scattering increases, and when a difference in refractive index between the liquid crystal phase domain and the non-liquid crystal phase domain decreases, the state becomes transparent. A structure including the liquid crystal phase domain and the non-liquid crystal phase domain in the light control layer can be checked using an SEM.

In order to scatter visible light, the size of the liquid crystal phase domain in the light control layer of the light control window when light is blocked is preferably 200 nm to 20 μm, more preferably 300 nm to 10 μm, and most preferably 380 nm to 2 μm.

The substrate used in the liquid crystal device may be made of a strong material, for example, glass or a metal, or a flexible material, for example, a plastic film. In addition, in the liquid crystal device, two substrates face each other with an appropriate interval therebetween.

In addition, at least one thereof has transparency, but it does not require complete transparency. If the liquid crystal device is used to act with light that passes from one side to the other side of the device, an appropriate transparency is provided to two substrates together.

An appropriate transparent or opaque electrode may be disposed on the entire surface or a partial surface of the substrate according to purposes thereof.

When the liquid crystal device of the present invention is used as a display device of a computer terminal, a projection display device, or the like, an active element is preferably provided on an electrode layer.

In addition, an alignment film made of a polyimide or the like may be disposed on the entire surface or a partial surface of at least one substrate as necessary. Incidentally, like a well-known liquid crystal device, generally, a spacer for keeping a distance can be interposed between two substrates.

As the spacer, for example, various types of spacer for liquid crystal cells such as those of Mylar, alumina, rod type glass fibers, glass beads, and polymer beads can be used.

The transparent material in the light control layer is formed of a polymer of the polymerizable compound included in the material for a liquid crystal device, but may be a material dispersed in a fibrous form or a particle form, a film-like material in which the above-described liquid crystal material is dispersed in a droplet form, or a gel material having a three-dimensional network structure.

In addition, the liquid crystal material preferably forms a continuous layer, and it is necessary to form liquid crystal molecules in a disordered state because an optical interface is formed and scattering of light is realized.

The transparent material used in the present invention is a polymer of the polymerizable compound and a content thereof can be adjusted according to application purposes. However, in order to obtain sufficient contrast between opacity and transparency due to light scattering, the transparent material is included in a range of 0.1 to 60 weight % in the light control layer, preferably in a range of 0.1 to 50 weight %, more preferably in a range of 1 to 20 weight %, and most preferably in a range of 3 to 15 weight %.

A liquid crystal device driven in a reverse mode of the present invention can be produced, for example, as follows.

That is, a material for a liquid crystal device formed of a liquid crystal material including at least one compound selected from among a polymerizable compound and the compounds represented by General Formulae (K1) and (K2) is interposed between two substrates each having an electrode layer and at least one of which is transparent, ultraviolet rays are emitted through the transparent substrate or the transparent substrate is heated, and thus the polymerizable compound is polymerized, and a liquid crystal device having a light control layer formed of a transparent material and a liquid crystal material can be produced.

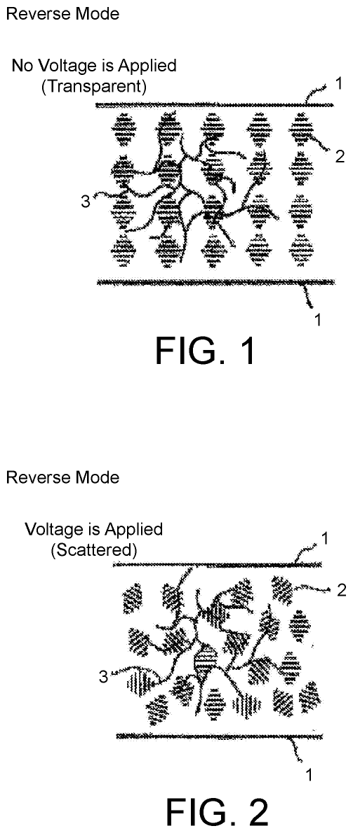

FIG. 1 and FIG. 2 show schematic diagrams as an example of a liquid crystal device driven in a reverse mode of the present invention. FIG. 1 shows a state in which no voltage is applied and alignment of a liquid crystal material is planar, and when light is transmitted, a panel becomes transparent.

FIG. 2 shows a state in which a voltage is applied, alignment of a liquid crystal material is focal conic, and when light is scattered, a panel becomes opaque.

A liquid crystal device driven in a normal mode of the present invention can be produced, for example, as follows.

That is, a material for a liquid crystal device formed of a liquid crystal material including a polymerizable compound and at least one compound selected from among the compounds represented by General Formulae (K1) and (K2) is interposed between two substrates each having an electrode layer and at least one of which is transparent, and while a saturation voltage of a liquid crystal material is applied, ultraviolet rays are emitted through the transparent substrate, or the transparent substrate is heated, and the polymerizable compound is polymerized, and thus a liquid crystal device having a light control layer formed of a transparent material and a liquid crystal material can be produced.

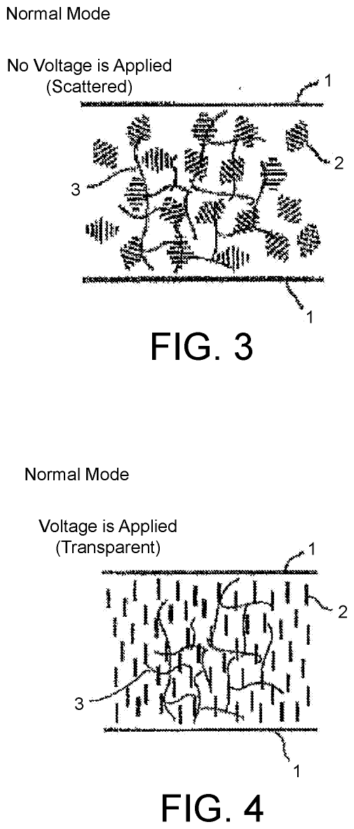

FIG. 3 and FIG. 4 show schematic diagrams as an example of a liquid crystal device driven in a normal mode of the present invention. FIG. 3 shows a state in which no voltage is applied and alignment of a liquid crystal material is focal conic, and when light is scattered, a panel becomes opaque.

FIG. 4 shows a state in which a voltage is applied, alignment of a liquid crystal material is homeotropic, and when light is transmitted, a panel becomes transparent.

Here, a method in which a material for a liquid crystal device which is a material forming a light control layer is interposed between two substrates is not particularly limited. The material for a liquid crystal device may be injected between substrates by a known injection technique. For example, the material may be uniformly applied to one substrate using an appropriate solution coating machine, a spin coater, or the like, and the other substrate may be then laminated and clamped.

Regarding the layer thickness of the light control layer having light scattering properties in the liquid crystal device of the present invention, the layer thickness can be adjusted according to application purposes. However, in order to obtain sufficient contrast between opacity and transparency due to light scattering, a substrate interval is preferably in a range of 2 to 40 μm and particularly preferably in a range of 6 to 25 μm.

Here, a method in which a material for a liquid crystal device which is a material forming a light control layer is interposed between two substrates is not particularly limited. The material for a liquid crystal device may be injected between substrates by a known injection technique. For example, the material may be uniformly applied to one substrate using an appropriate solution coating machine, a spin coater, or the like, and the other substrate may be then laminated and clamped.

The thickness of the light control layer having light scattering properties in the liquid crystal device of the present invention can be appropriately adjusted according to application purposes. However, in order to obtain sufficient contrast between opacity and transparency due to light scattering, a substrate interval (the thickness of the light control layer) is preferably in a range of 2 to 40 μm and particularly preferably in a range of 6 to 25 μm.

The liquid crystal device having a light control layer obtained in the present invention as a light control window or a light modulation device can be used for various applications such as building applications such as for interior decoration, and automobile applications such as an automobile leaf.

### EXAMPLES

The present invention will be described below in further detail with reference to examples of the present invention. However, the present invention is not limited to these examples.

In the examples, (8H) BN-H5 used as a chiral agent is represented by the following chemical formula.

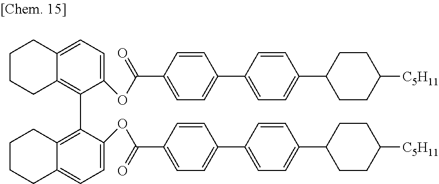

For trimethylolpropane triacrylate in the examples, a product (commercially available from Toagosei Co., Ltd.) was used. In addition, for 2-hydroxy-2-methyl-1-phenyl-propan-1-one used in the examples, IRGACURE 1173 was used. IRGACURE is a registered trademark (commercially available from BASF).

In this example, room temperature refers to 15 to 30° C. Unless otherwise noted, the temperature was room temperature in the examples.

(Method of Measuring Transition Temperature)

A sample was placed on a hot plate of a melting point measurement device including a polarizing microscope and heated at a specific rate. A temperature at which a part of the sample changed from a nematic phase to an isotropic liquid was measured and set as a “transition temperature from a chiral nematic phase to an isotropic liquid” of the sample.

A sample was placed on the hot plate of the melting point measurement device including a polarizing microscope and cooled at a specific rate. A temperature at which a part of the sample changed from an isotropic liquid to a nematic phase was measured and set as a “transition temperature from an isotropic liquid to a nematic phase” of the sample.

For the hot plate of the melting point measurement device, a 10083L large sample cooling and heating stage (commercially available from LINKAN) was used.

<Method of Measuring Average Refractive Index>

An average refractive index was obtained by the following procedures.

(1) An ordinary light refractive index of a sample with respect to a white light source of a lamp was measured using an Abbe refractometer.

(2) An extraordinary light refractive index of the sample with respect to a white light source of a lamp was measured using the Abbe refractometer.

(3) An average refractive index was calculated according to ((ordinary light refractive index²+extraordinary light refractive index²)/2)/^{1/2}.

<Method of Measuring Peak Wavelength for Selective Reflection>

The sample was interposed between anti-parallel cells and a peak wavelength for selective reflection was measured. A UV-visible spectrophotometer V650DS (commercially available from JASCO Corporation) was used to measure a peak wavelength for selective reflection. A bandwidth of incident light in this case was 5 nm. For the anti-parallel cells, a KSRP-07/A107PINSS05 (commercially available from EHC) with a cell gap of 7 μm was used.

<Method of Calculating Helical Twisting Power (HTP)>

A helical twisting power (HTP) was calculated according to average refractive index/(peak wavelength for selective reflection*chiral concentration).

<Calculation of Contrast Ratio>

A contrast ratio is a ratio between a transmitted light intensity under certain circumstances and a transmitted light intensity under different circumstances.

<Measurement of Rotational Viscosity>

A rotational viscosity was measured by the following procedures.

(1) A sample was put into a TN element with a twist angle of 0° and an interval between two glass substrates of 5 μm,

(2) Voltages from 16 V to 19.5 V were gradually applied to the TN element in intervals of 0.5 V,

(3) Subsequently, no voltage was applied to the TN element for 0.2 seconds,

(4) Subsequently, application of a square wave for 0.2 seconds to the TN element and no application for 2 seconds were repeated, and a peak current and a peak time of a transient current generated when the square wave was applied were measured, and

(5) A rotational viscosity was obtained using Calculation Formula (8) on page 40 in M. Imai et al., Molecular Crystals and Liquid Crystals, Vol. 259, 37 (1995).

When the rotational viscosity was measured, details not described in the examples in this specification are described in M. Imai et al., Molecular Crystals and Liquid Crystals, Vol. 259, 37 (1995).

<Measurement of ε∥ and Δε>

ε∥, ε⊥ and Δε were obtained by the following procedures.

(1) A sample was put into a TN element with an interval between two glass substrates of 10 μm and a twist angle of 80 degrees,

(2) A sine wave of 10 V and 1 kHz was applied to the element, and a dielectric constant of liquid crystal molecules in the long axis direction was measured after 2 seconds, and set as ε∥,

(3) A sine wave of 0.5 V and 1 kHz was applied to the element, and a dielectric constant of liquid crystal molecules in the short axis direction was measured after 2 seconds and set as ε⊥, and

(4) A value of ε∥-ε⊥ was set as Δε.

<Measurement of Transmitted Light Intensity of Cell and Calculation of Transmittance of Cell>

A cell was placed in a UV-visible spectrophotometer V650DS (commercially available from JASCO Corporation) so that light of a light source was perpendicular to a surface of the cell, and a transmitted light intensity with a wavelength of 450 nm was measured. A bandwidth of incident light in this case was 5 nm. The transmittance % of the cell was calculated according to “transmitted light intensity of measurement target cell/(light intensity measured when the measurement target cell was not placed in the spectrometer)*100.” An electric field applying unit and a bipolar power supply were used to measure a transmitted light intensity of a cell when a voltage was applied to the cell and a transmitted light intensity of a cell when no voltage was applied. The electric field applying unit was a 33210A (commercially available from Agilent). The bipolar power supply was a 4010 (commercially available from NF Electronic Instruments).

### Example 1

All compounds shown in Table 1 were liquid crystal compounds. The compounds were added in proportions shown on the right side in Table 1 to prepare a liquid crystal composition NLC-A. An average refractive index of NLC-A at 25° C. was 1.6, Δn was 0.160, and Δε was 113.

TABLE 1

| | |
|---|---|
| 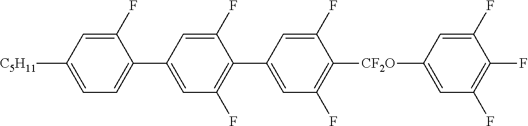 | 2.2 wt % |
| 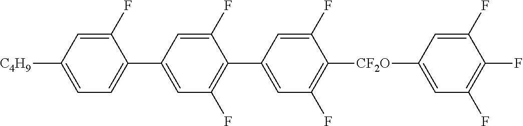 | 2.2 wt % |
| 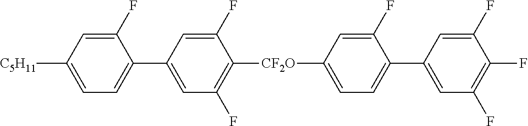 | 3.0 wt % |
| 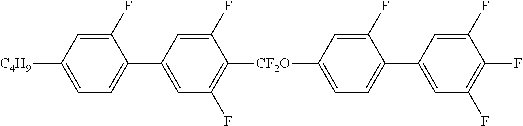 | 3.0 wt % |
| 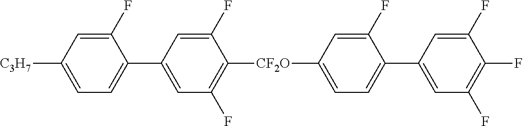 | 3.0 wt % |
| 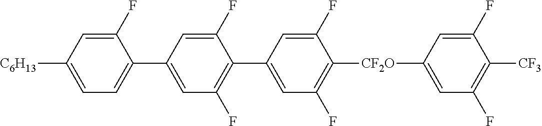 | 3.8 wt % |
| 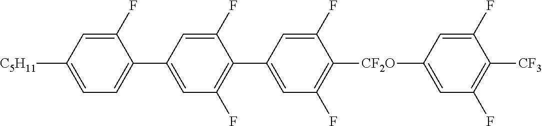 | 3.8 wt % |
| 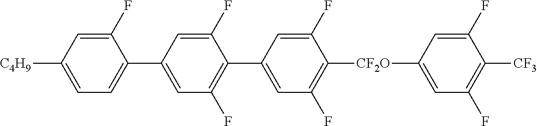 | 3.8 wt % |
| 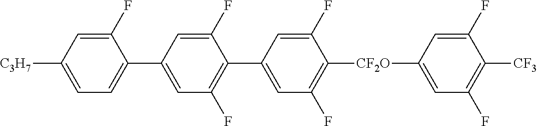 | 3.8 wt % |
| 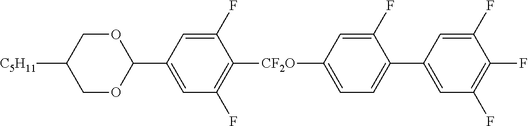 | 9.0 wt % |
| 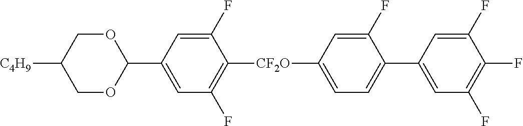 | 9.0 wt % |
| 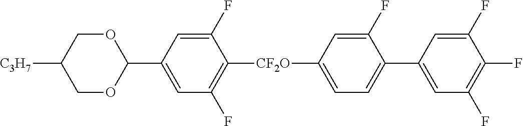 | 8.4 wt % |
| 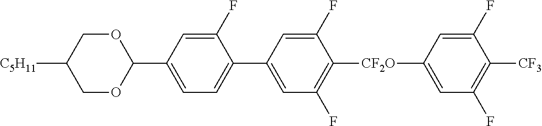 | 15.0 wt % |
| 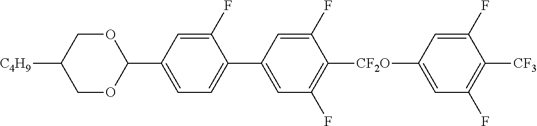 | 15.0 wt % |
| 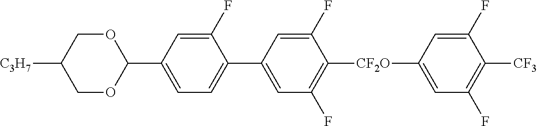 | 15.0 wt % |

The liquid crystal composition NLC-A and (8H) BN-H5 were mixed at a ratio of w/w=99/1 to prepare a liquid crystal composition CLC-A. NLC-A and (8H) BN-H5 were 5 mixed at a ratio ofw/w=98/2 to prepare CLC-B.

A transition temperature of the liquid crystal composition NLC-A from a nematic phase to an isotropic liquid was 89.4° C. The transition temperature was measured while heating at a rate of 2.0° C./min.

A phase transition temperature of the liquid crystal composition CLC-A from a chiral nematic phase to an isotropic liquid was 87° C. The transition temperature was measured while heating at a rate of 2.0 C/min.

A phase transition temperature of the liquid crystal composition CLC-A from an isotropic liquid to a chiral nematic phase was 85° C. The transition temperature was measured while cooling at a rate of 2.0° C./min.

A helical pitch of the liquid crystal composition CLC-A was 0.68 μm.

A peak wavelength for selective reflection of CLC-B was 539 nm. Thus, a helical twisting power (HTP) was 148.

### Example 2

<Liquid Crystal Material>

The liquid crystal composition CLC-A, n-dodecyl acrylate, trimethylolpropane triacrylate, and 2-hydroxy-2-methyl-1-phenyl-propan-1-one were mixed at a ratio of w/w/w/w=80.0/17.0/2.7/0.3 to prepare a liquid crystal composition MLC-A.

n-Dodecyl acrylate and trimethylolpropane triacrylate were polymer forming monomers. 2-Hydroxy-2-methyl-1-phenyl-propan-1-one was a photopolymerization initiator.

A phase transition temperature of the liquid crystal composition MLC-A from a chiral nematic phase to an isotropic liquid was 8° C. The transition temperature was measured while heating at a rate of 2.0° C./min.

A phase transition temperature of the liquid crystal composition MLC-A from an isotropic liquid to a chiral nematic phase was 6° C. The transition temperature was measured while heating at a rate of 2.0° C./min.

### Example 3

<Preparation Polymer/Liquid Crystal Composite Material PDLC-A>

A polymer/liquid crystal composite material PDLC-A was prepared by the following procedures.

(1) Two glass substrates with electrodes of two transparent conductive films on which no alignment treatment was performed were disposed so that a width between the glass substrates was 10 μm and the electrodes were on the inside, and a liquid crystal composition MLC-A was inserted between the glass substrates to prepare a cell.

(2) The cell was heated until the liquid crystal composition MLC-A reached an isotropic phase. A temperature at which the liquid crystal composition MLC-A reached an isotropic phase was 82° C.

(3) Light with a wavelength of 365 nm was emitted for 1 minute at 23 mWcm² and a liquid crystal composition in the cell was polymerized.

(4) It was confirmed that a material between the glass substrates remained in a chiral nematic liquid crystal phase even when cooled to room temperature.

For the glass substrate, KSSZ-10/A107P1NSS05 (commercially available from EHC) was used. When a voltage was applied between electrodes of the glass substrates, an electric field could be applied to the liquid crystal composition MLC-A between the glass substrates.

Here, the transparent conductive film was ITO. The size of the transparent conductive film was 10 mm×10 mm. A potential difference was generated between two substrates, and an electric field was applied to the inserted liquid crystal composition.

<Electro-Optical Characteristics of Polymer/Liquid Crystal Composite Material PDLC-A>

A polymer/liquid crystal composite material PDLC-A was disposed so that light of a light source was perpendicular to a surface of the cell, and electro-optical characteristics of the polymer/liquid crystal composite material PDLC-A were measured using an electric field applying unit and a bipolar power supply.

An Eclipse LV100POL (commercially available from Nikon) was used as a polarizing microscope. A white light source of the polarizing microscope was used as a light source. A YOKOGAWA 3298F was used as a luminance meter.

A waveform generator 3320A (commercially available from Keysight Technologies) was used as the electric field applying unit. An Electronic Instruments 4010 (commercially available from NF) was used as the bipolar power supply.

The relationship between an applied voltage and a transmitted light intensity in a crossed Nicols state was examined at room temperature using the following procedures.

(1) A voltage of the electrodes of two transparent conductive films was raised from 0 V to 40 V. A transmitted light intensity was measured for each applied voltage in this case.

(2) Then, a voltage of the electrodes of two transparent conductive films was lowered from 40 V to 0 V. A transmitted light intensity was measured for each applied voltage in this case.

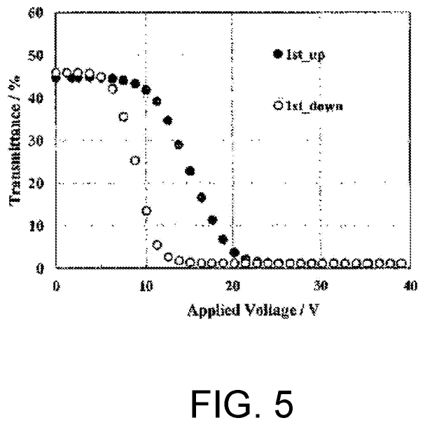

FIG. 5 shows curves of an applied voltage and a transmittance between electrodes of the polymer/liquid crystal composite material PDLC-A. A transmittance with respect a voltage when the voltage between electrodes was raised from 0 V to 40 V is indicated by black dots. A transmittance with respect to a voltage when the voltage between electrodes was lowered from 0 V to 40 V is indicated by white dots.

It was confirmed that a square wave of 20 V was applied and the polymer/liquid crystal composite material PDLC-A was driven in a normal mode.

A contrast ratio between when no voltage was applied between electrodes of the polymer/liquid crystal composite material PDLC-A and when a voltage of 30 V was applied between electrodes of the polymer/liquid crystal composite material PDLC-A was high at 40.

When a voltage of 10 V was applied between electrodes of the polymer/liquid crystal composite material PDLC-A, a transmitted light intensity became 90% with respect to a case in which no voltage was applied. When a voltage of 20 V was applied between electrodes of the polymer/liquid crystal composite material PDLC-A, a transmitted light intensity became 10% with respect to a case in which no voltage was applied. In this manner, driving was performed at a low driving voltage.

### Example 4

<Preparation of liquid crystal composition (4-1)>

A liquid crystal composition (4-1) was prepared by mixing together compounds shown in Table 2. Those skilled in the art can synthesize compounds shown in Table 2 with reference to methods described in WO96/11897, WO2005/007775, and Published Japanese Translation No. 2003-518154.

TABLE 2

| Structure of compound | Compositional proportion of compound |
|---|---|
| 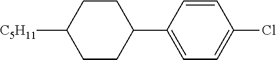 | 12 wt % |
| 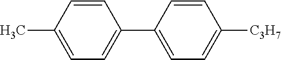 | 10 wt % |
| 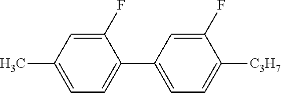 | 6 wt % |
| 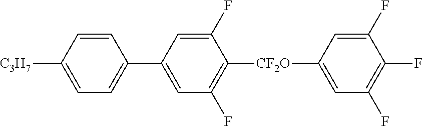 | 20 wt % |
| 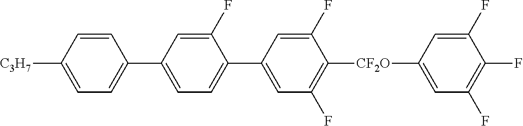 | 4 wt % |
| 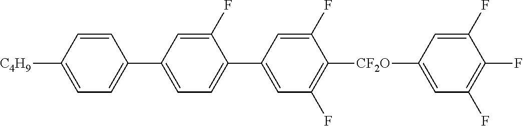 | 4 wt % |
| 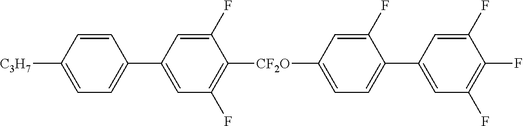 | 13 wt % |
| 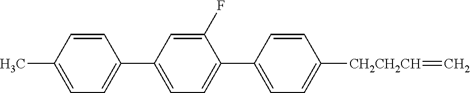 | 3 wt % |
| 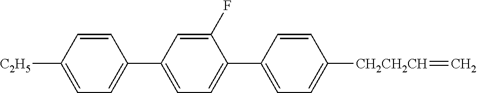 | 4 wt % |
| 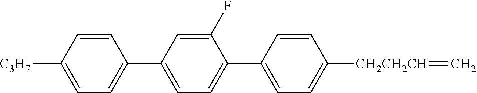 | 4 wt % |
| 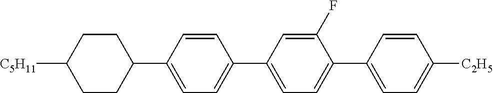 | 6 wt % |
| 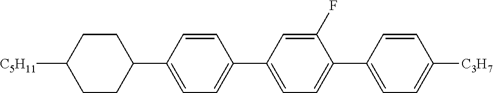 | 6 wt % |
| 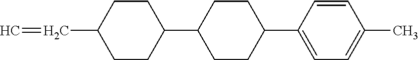 [SMILES: C=CC1CCC(C2CCC(c3ccc(C)cc3)CC2)CC1] | 8 wt % |

<Preparation of Liquid Crystal Composition (4-2)>

The liquid crystal composition (4-1) and Irgacure (trademark) 651 were mixed at a weight ratio of 100/0.3 to prepare a liquid crystal composition (4-2). Irgacure (trademark) 651 was 2,2-dimethoxy-1,2-diphenylethan-1-one.

<Preparation of Liquid Crystal Composition (4-3)>

The liquid crystal composition (4-2) and (8H) BN-H5 were mixed at a weight ratio of 99.1/0.9 to prepare a liquid crystal composition (4-3).

Physical property data of the liquid crystal composition (4-1) and the liquid crystal composition (4-3) is shown in Table 3.

TABLE 3

| | Liquid crystal | Liquid crystal |
|---|---|---|
| Name of liquid crystal composition | composition (4-1) | composition (4-3) |
| Transition temperature from liquid | 79.7° C. | 78.3° C. |
| crystal phase to isotropic liquid | | |
| phase/° C. | | |
| Rotational viscosity/(mPa · s) | 39 | 45.7 |
| Δn | 0.179 | |
| Ordinary light refractive index | 1.509 | |
| Extraordinary light refractive index | 1.688 | |
| Δε | 13.2 | |
| ε∥ | 17.3 | |
| ε⊥ | 4.1 | |

The liquid crystal composition (4-1) was in a nematic phase at 25° C. The liquid crystal composition (4-3) was in a chiral nematic phase at 25° C. A helical pitch of the liquid crystal composition (4-3) was 1.03 μm.

<Preparation of Liquid Crystal Composition (B)>

The liquid crystal composition (4-3) and tetraethylene glycol diacrylate were mixed at a weight ratio of 96.3:3.7 to prepare a liquid crystal composition (B). Tetraethylene glycol diacrylate was a polymer forming monomer.

<Preparation of Liquid Crystal Composition (C)>

The liquid crystal composition (4-3) and 1,10-decanediol diacrylate were mixed at a weight ratio of 96.2:3.8 to prepare a liquid crystal composition (C). 1,10-Decanediol diacrylate was a polymer forming monomer.

<Preparation of Liquid Crystal Composition (D)>

The liquid crystal composition (4-3) and a polymerizable liquid crystal compound (hereinafter also referred to as a compound δ) represented by the following Chemical Formula (6) were mixed at a weight ratio of 93.8:6.2 to prepare a liquid crystal composition (D).

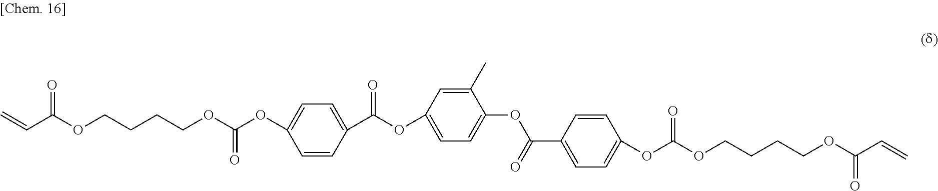 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]

Those skilled in the art can synthesize the compound δ with reference to Japanese Patent No. 4063873.

Here, a transition temperature of the compound δ from a crystal phase to a nematic phase was 60.3° C. A transition temperature of the compound δ from a nematic phase to an isotropic liquid was 124.4° C. An extraordinary light refractive index of the compound δ was 1.6370. An ordinary light refractive index of the compound δ was 1.4924.

The compound δ was a polymer forming monomer having two acrylate groups. The pure substance compound δ had a liquid crystal phase.

<Preparation of Polymer/Liquid Crystal Composite Material PDLC-B>

In preparation of the polymer/liquid crystal composite material PDLC-A, the liquid crystal composition MLC-A was replaced with the liquid crystal composition (B) and when a polymerization reaction was caused to occur, while a voltage of 30 V was applied between transparent conductive films, light with a wavelength of 365 nm was emitted for 1 minute at 15 mWcm⁻², and the liquid crystal composition in the cell was polymerized to prepare a polymer/liquid crystal composite material PDLC-B.

<Preparation of Polymer/Liquid Crystal Composite Material PDLC-C>

In preparation of the polymer/liquid crystal composite material PDLC-A, the liquid crystal composition MLC-A was replaced with the liquid crystal composition (C), and when a polymerization reaction was caused to occur, while a voltage of 30 V was applied between transparent conductive films, light with a wavelength of 365 nm was emitted for 1 minute at 15 mWcm⁻² and the liquid crystal composition in the cell was polymerized to prepare a polymer/liquid crystal composite material PDLC-C.

<Preparation of Polymer/Liquid Crystal Composite Material PDLC-D>

In preparation of the polymer/liquid crystal composite material PDLC-A, the liquid crystal composition MLC-A was replaced with the liquid crystal composition (D), and when a polymerization reaction was caused to occur, while a voltage of 30 V was applied between transparent conductive films, light with a wavelength of 365 nm was emitted for 7 minutes at 2.1 mWcm⁻² and the liquid crystal composition in the cell was polymerized to prepare a polymer/liquid crystal composite material PDLC-D.

<Preparation of Polymer/Liquid Crystal Composite Material PDLC-E>

In preparation of the polymer/liquid crystal composite material PDLC-A, the liquid crystal composition MLC-A was replaced with the liquid crystal composition (D), and when a polymerization reaction was caused to occur, while a voltage of 50 V was applied between transparent conductive films, light with a wavelength of 365 nm was emitted for 7 minutes at 2.1 mWcm⁻², and the liquid crystal composition in the cell was polymerized to prepare a polymer/liquid crystal composite material PDLC-E.

<Measurement of Transmittance of Cell>

A transmittance of a measurement cell when no applied voltage was applied to the measurement cell was measured and listed in A in Table 4.

A transmittance of a measurement cell when an applied voltage of 30 V was applied to the measurement cell was measured and listed in B in Table 4.

A value of (transmittance in A)/(transmittance described in B) is shown in Table 4. A/B is a contrast ratio.

TABLE 4

| | A | B | A/B |
|---|---|---|---|
| Polymer/liquid crystal | 5 | 81 | 16.2 |
| composite material PDLC-B | | | |
| polymer/liquid crystal | 10 | 83 | 8.3 |
| composite material PDLC-C | | | |
| polymer/liquid crystal | 6 | 82 | 13.7 |
| composite material PDLC-D | | | |
| polymer/liquid crystal | 4 | 79 | 19.8 |
| composite material PDLC-E | | | |

According to the present invention, a liquid crystal device with high contrast was obtained.

<Measurement of Haze of Cell and Measurement of Parallel Light Transmittance of Cell>

A cell was placed in a Haze Meter NDH5000 (commercially available from Nippon Denshoku Industries Co., Ltd.) so that light of a light source was perpendicular to a surface of the cell, and a haze and a parallel light transmittance at room temperature were measured.

### Example 7

<Preparation of Liquid Crystal Composition (7-1)>

The liquid crystal composition (4-1) and Irgacure (trademark) 651 were mixed at a weight ratio of 100/1.2 to prepare a liquid crystal composition (7-1). Irgacure (trademark) 651 was 2,2-dimethoxy-1,2-diphenylethan-1-one.

<Preparation of Liquid Crystal Composition (7-2)>

The liquid crystal composition (7-1) and (8H) BN-H5 were mixed at a weight ratio of 100/0.9 to prepare a liquid crystal composition (7-2).

The liquid crystal composition (4-1) was in a nematic phase at 25° C. The liquid crystal composition (7-2) was in a chiral nematic phase at 25° C. A helical pitch of the liquid crystal composition (7-2) was 1.03 μm.

<Preparation of Liquid Crystal Composition (7-3)>

The liquid crystal composition (7-1) and (8H) BN-H5 were mixed at a weight ratio of 100/1.9 to prepare a liquid crystal composition (7-3).

The liquid crystal composition (7-3) was in a chiral nematic phase at 25° C. A helical pitch of the liquid crystal composition (7-3) was 0.47 μm.

<Preparation of Liquid Crystal Composition (7-4)>

The liquid crystal composition (7-1) and (8H) BN-H5 were mixed at a weight ratio of 100/4.2 to prepare a liquid crystal composition (7-4).

The liquid crystal composition (7-4) was in a chiral nematic phase at 25° C. A helical pitch of the liquid crystal composition (7-4) was 0.22 μm.

<Preparation of Liquid Crystal Composition (7-5)>

The liquid crystal composition (7-1) and CM33 were mixed at a weight ratio of 100/30 to prepare a liquid crystal composition (7-5).

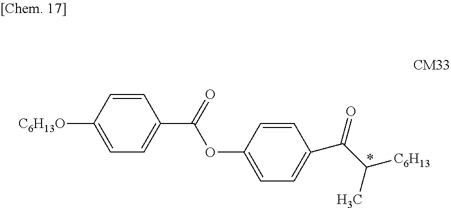

The liquid crystal composition (7-5) was in a chiral nematic phase at 25° C. A helical pitch of the liquid crystal composition (7-5) was 0.47 μm.

<Preparation of Liquid Crystal Composition (F)>

The liquid crystal composition (7-2) and tripropylene glycol diacrylate were mixed at a weight ratio of 88:12 to prepare a liquid crystal composition (F). Tripropylene glycol diacrylate was a polymer forming monomer.

<Preparation of Liquid Crystal Composition (G)>

The liquid crystal composition (7-3) and the compound δ were mixed at a weight ratio of 95:5 to prepare a liquid crystal composition (G). The compound δ was a polymer forming monomer.

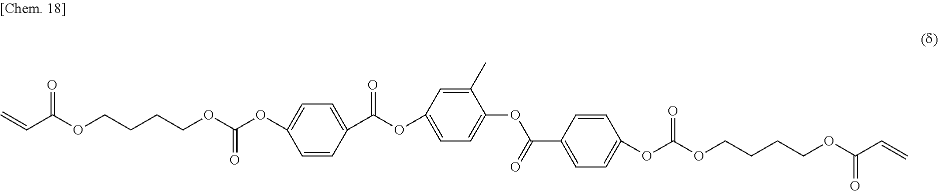 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]

<Preparation of Liquid Crystal Composition (H)>

The liquid crystal composition (7-4) and a polymerizable liquid crystal compound represented by the following Chemical Formula (M-1) (hereinafter referred to as Compound M-1) were mixed at a weight ratio of 90:10 to prepare a liquid crystal composition (H).

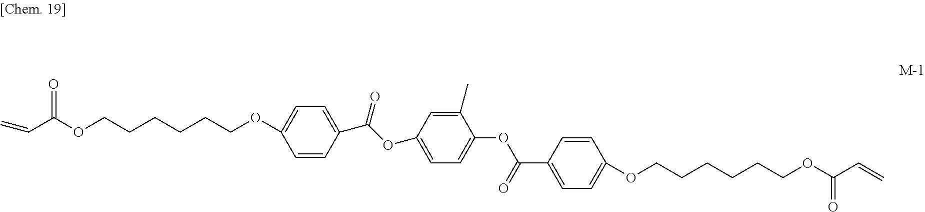 [SMILES: C=CC(=O)OCCCCCCOc1ccc(C(=O)Oc2ccc(OC(=O)c3ccc(OCCCCCCOC(=O)C=C)cc3)c(C)c2)cc1]

Those skilled in the art can synthesize the above compound M-1 with reference to Macromolecules 1990, 23, 2474-2477 and the like.

Here, a transition temperature of Compound M-1 from a crystal phase to a nematic phase was 83.6° C. A transition temperature of Compound M-1 from a nematic phase to an isotropic liquid was 116.9° C. An extraordinary light refractive index of Compound M-1 was 1.6627. An ordinary light refractive index of Compound M-1 was 1.5048.

Compound M-1 was a polymer forming monomer having two acrylate groups. The pure substance compound M-1 had a liquid crystal phase.

<Preparation of Liquid Crystal Composition (I)>

The liquid crystal composition (7-5) and the compound δ were mixed at a weight ratio of 95:5 to prepare a liquid crystal composition (I). The compound δ was a polymer forming monomer.

<Preparation of Polymer/Liquid Crystal Composite Material PDLC-F>

The polymer/liquid crystal composite material PDLC-F was prepared by the following procedures.

(1) Two glass substrates with electrodes of two transparent conductive films on which no alignment treatment was performed were disposed so that a width between the glass substrates was 5 μm and the electrodes were on the inside, and a liquid crystal composition (F) was inserted between the glass substrates at room temperature to prepare a cell.

(2) Light with a wavelength of 365 nm was emitted for 72 seconds at 14 mWcm⁻² and a liquid crystal composition in the cell was polymerized.

(3) It was confirmed that a material between the glass substrates after the polymerization reaction remained in a chiral nematic liquid crystal phase.

For the glass substrate, KSSZ-5/A107P1NSS05 (commercially available from EHC) was used. When a voltage was applied between electrodes of the glass substrate, an electric field could be applied to the liquid crystal composition G between the glass substrates.

Here, the transparent conductive film was ITO. The size of the transparent conductive film was 10 mm×10 mm. A potential difference was generated between two substrates, and an electric field was applied to the inserted liquid crystal composition.

A polymer/liquid crystal composite material PDLC-G was prepared by the following procedures.

(1) Two glass substrates with electrodes of two transparent conductive films on which a horizontal alignment treatment was performed were disposed so that a width between the glass substrates was 7 μm and the electrodes were on the inside, and while a gap between the glass substrates was heated to 80° C., a liquid crystal composition (G) was inserted, and a cell was prepared and then cooled to room temperature.

(2) Light with a wavelength of 365 nm was emitted for 500 seconds at 2 mWcm², and a liquid crystal composition in the cell was polymerized.

(3) It was confirmed that a material between the glass substrates after the polymerization reaction remained in a chiral nematic liquid crystal phase.

For the glass substrate, KSRP-07/A107P1NSS05 (commercially available from EHC) was used. When a voltage was applied between electrodes of the glass substrate, an electric field could be applied to the liquid crystal composition G between the glass substrates.

Here, the transparent conductive film was ITO. The size of the transparent conductive film was 10 mm×10 mm. A potential difference was generated between two substrates, and an electric field was applied to the inserted liquid crystal composition.

<Preparation of Polymer/Liquid Crystal Composite Material PDLC-H>

In preparation of the polymer/liquid crystal composite material PDLC-H, the liquid crystal composition (G) was replaced with the liquid crystal composition (H) to prepare a polymer/liquid crystal composite material PDLC-H.

<Preparation of Polymer/Liquid Crystal Composite Material PDLC-I>

In preparation of the polymer/liquid crystal composite material PDLC-I, the liquid crystal composition (G) was replaced with the liquid crystal composition (I) to prepare a polymer/liquid crystal composite material PDLC-I.

<Measurement of Haze and Parallel Light Transmittance of Polymer/Liquid Crystal Composite Material PDLC-F>

A polymer/liquid crystal composite material PDLC-F was put into a haze meter so that light of a light source was perpendicular to a surface of the cell. A voltage of 0 to 50 V was applied to the cell, and a haze and a parallel light transmittance were measured.

B indicates a haze and D indicates a parallel light transmittance when no applied voltage was applied to a measurement cell. A indicates a haze and C indicates a parallel light transmittance when a voltage was applied to the measurement cell. When no applied voltage was applied to the measurement cell, a haze and a parallel light transmittance of the measurement cell were measured and listed in B and D in Table 5. A haze and a parallel light transmittance of the measurement cell when an applied voltage of 50 V was applied to the measurement cell were measured and listed in A and C in Table 5.

<Measurement of Haze and Parallel Light Transmittance of Polymer/Liquid Crystal Composite Material PDLC-G>

A polymer/liquid crystal composite material PDLC-G was put into a haze meter so that light of a light source was perpendicular to a surface of the cell. A voltage of 0 to 60 V was applied to the cell, and a haze and a parallel light transmittance were measured.

A haze and a parallel light transmittance of the measurement cell were measured when no voltage was applied to the measurement cell and listed in B and D in Table 5. A haze and a parallel light transmittance of the measurement cell when an applied voltage of 30 V was applied to the measurement cell were measured and listed in A and C in Table 5.

<Measurement of Haze and Parallel Light Transmittance of Polymer/Liquid Crystal Composite Material PDLC-H>

A polymer/liquid crystal composite material PDLC-H was put into a haze meter so that light of a light source was perpendicular to a surface of the cell. A voltage of 0 to 60 V was applied to the cell, and a haze and a parallel light transmittance were measured.

A haze and a parallel light transmittance of the measurement cell when no voltage was applied to the measurement cell were measured and listed in B and D in the table. A haze and a parallel light transmittance of the measurement cell when an applied voltage of 40 V was applied to the measurement cell were measured and listed in A and C in Table 5.

### Comparative Example

<Measurement of Haze and Parallel Light Transmittance of Polymer/Liquid Crystal Composite Material PDLC-I>

A polymer/liquid crystal composite material PDLC-I was put into a haze meter so that light of a light source was perpendicular to a surface of the cell. A voltage of 0 to 60 V was applied to the cell, and a haze and a parallel light transmittance were measured.

A haze and a parallel light transmittance of the measurement cell were measured when no voltage was applied to the measurement cell and listed in B and D in Table 5. A haze and a parallel light transmittance of the measurement cell when an applied voltage of 30 V was applied to the measurement cell were measured and listed in A and C in Table 5. No change was observed in the haze while a voltage of 60 V was applied.

TABLE 5

| | | | Parallel light | Parallel light | |
|---|---|---|---|---|---|
| | Haze % | | transmittance % | transmittance % | |
| Polymer/ | Applied | Applied | Applied | Applied | Voltage V of |
| liquid crystal | voltage ON | voltage OFF | voltage ON | voltage OFF | cell when voltage |
| composite material | A | B | C | D | was applied |
| PDLC-F | 6 | 60 | 83 | 33 | 50 |
| PDLC-G | 62 | 2 | 30 | 81 | 30 |
| PDLC-H | 54 | 4 | 39 | 82 | 40 |
| PDLC-I | 2 | 2 | 80 | 79 | 30 |
| (comparative | | | | | |
| example) | | | | | |

In the PDLC-F, PDLC-G, and PDLC-H materials, scattering and transmission states when no voltage was applied and when a voltage was applied were maintained near 40° C.

According to the present invention, a liquid crystal device having a large change in the haze and parallel light transmittance between when a voltage is applied and when no voltage is applied is obtained. In addition, since the obtained light control window can block or transmit light even at a low driving voltage, it has high contrast characteristics.

### REFERENCE SIGNS LIST

1 Substrate having electrode layer
2 Liquid crystal material
3 Transparent material

1. A material for a liquid crystal device formed of a liquid crystal material comprising at least one polymerizable compound and at least one compound selected from among compounds represented by General Formulae (K1) and (K2): 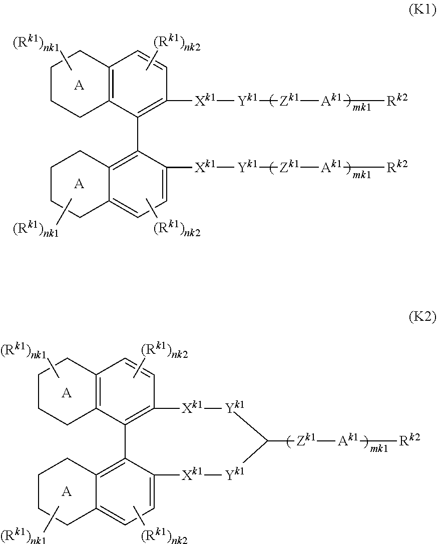
in Formulae (K1) and (K2),
R^{k1} is independently a hydrogen atom, a halogen atom, a cyano group, —SF₅, or an alkyl group having 1 to 5 carbon atoms, at least one —CH₂— in the alkyl group is optionally replaced with —O—, —COO— or —OCO—, at least one —CH₂—CH₂— is optionally replaced with —CH═CH— or —C≡C—, and two consecutive —CH₂— are not replaced with —O—, and at least one hydrogen atom in the alkyl group is optionally replaced with a halogen atom;
R^{k2} is independently a hydrogen atom, a halogen atom, a cyano group, —SF₅, or an alkyl group having 1 to 20 carbon atoms, at least one —CH₂— in the alkyl group is optionally replaced with —O—, —COO— or —OCO—, at least one —CH₂—CH₂— is optionally replaced with —CH═CH— or —C≡C—, and two consecutive —CH₂— are not replaced with —O—, and at least one hydrogen atom in the alkyl group is optionally replaced with a halogen atom;
the ring A is a ring that is linked to a phenylene ring to form a polycyclic structure and is independently 1,2-phenylene or 1,2-cyclohexylene;
the ring A^{k1} has a ring structure having two binding sites and is independently 1,4-phenylene, 1,4-cyclohexylene, 1,3-dioxane-2,5-diyl, tetrahydropyran-2,5-diyl, tetrahydropyran-3,5-diyl, pyrimidine-2,5-diyl, pyridine-2,5-diyl, or 1,4-bicyclo-(2,2,2)-octylene, and in these rings, at least one hydrogen atom is optionally replaced with a halogen atom;
X^{k1} is independently a single bond, —O—, —CO—, —COO—, —OCO—, —OCH₂—, —CH₂O—, —CF₂O—, —OCF₂—, —CH═CH—, —CF₂CF₂—, —CF═CF—, or —C≡C—;
Y^{k1} is independently a single bond or —(CH₂)ₙ—, and n is an integer of 1 to 20;
Z^{k1} is independently a single bond or an alkylene group having 1 to 10 carbon atoms, at least one —CH₂— in the alkylene group is optionally replaced with —O—, —COO— or —OCO—, at least one —CH₂—CH₂— is optionally replaced with —CH═CH—, —CF═CF— or —C≡C—, and at least one hydrogen atom in the alkylene group is optionally replaced with a halogen atom, provided that those having —O—O— in Z^{k1} are excluded;
mk1 is independently an integer of 2 to 4; and
nk1 and nk2 are independently an integer of 0 to 2.

2. The material for a liquid crystal device according to claim 1,
wherein the compounds represented by General Formulae (K1) and (K2) is Formulae (K101) to (K106) or (K201) to (K206): 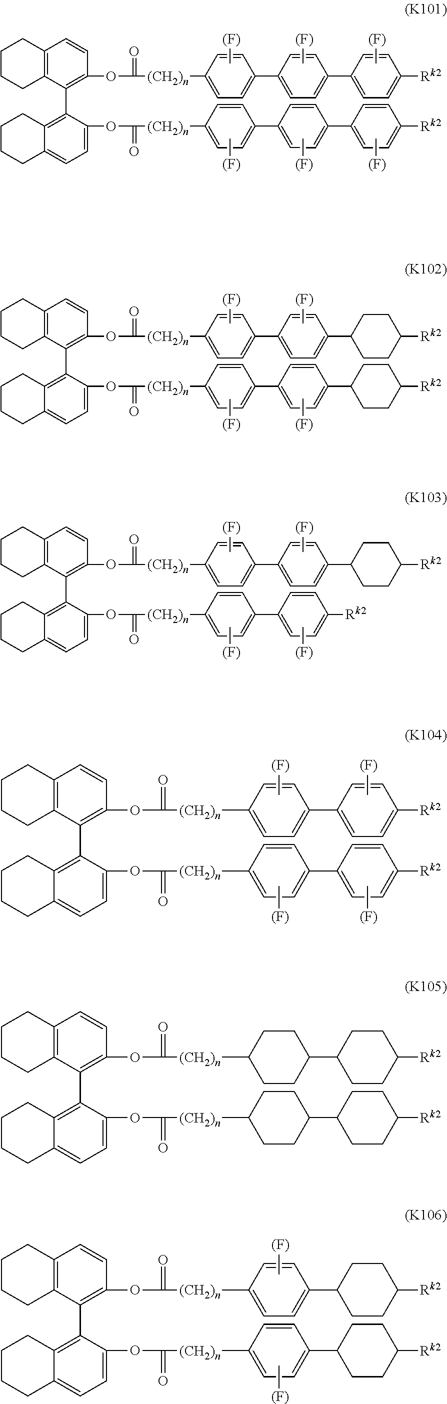 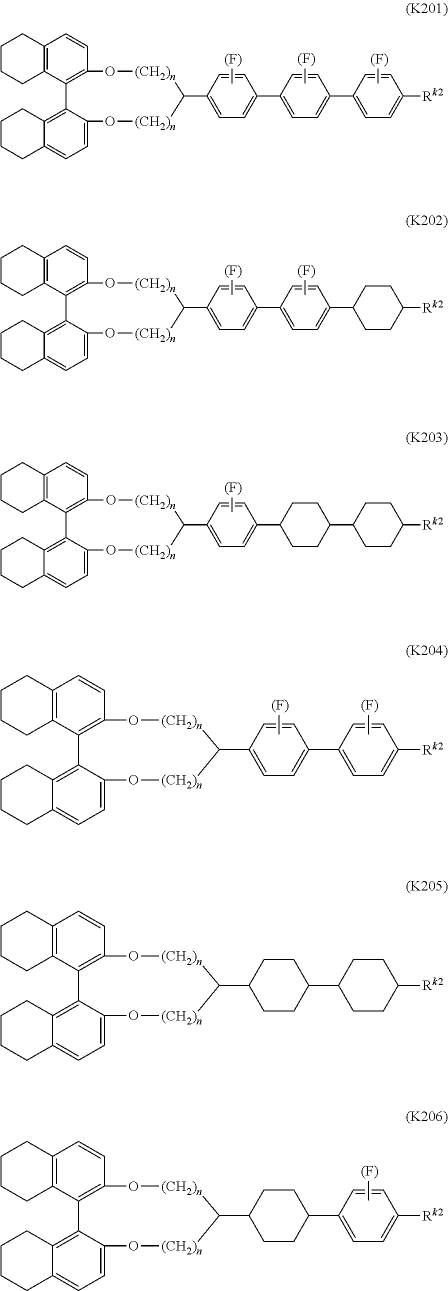
in Formulae (K101) to (K106) and Formulae (K201) to (K206),
R^{k2} is independently a hydrogen atom, a halogen atom, a cyano group, —SF₅, or an alkyl group having 1 to 20 carbon atoms,
n is independently an integer of 1 to 20,
provided that Partial Structural Formula (X1) and Formula (X2) 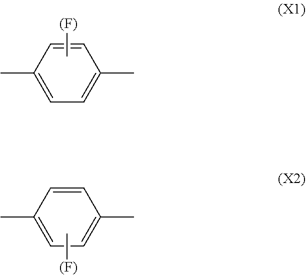
are independently 1,4-phenylene in which any hydrogen atom is optionally replaced with one or two fluorine atoms.

3. The material for a liquid crystal device according to claim 2,
wherein, in the compounds represented by Formulae (K101) to (K106), n is 0.

4. The material for a liquid crystal device according to claim 2,
wherein, in the compounds represented by Formulae (K201) to (K206), n is 1.

5. The material for a liquid crystal device according to claim 1,
wherein the liquid crystal material further comprises a compound represented by Formula (1-A) or (1-B): 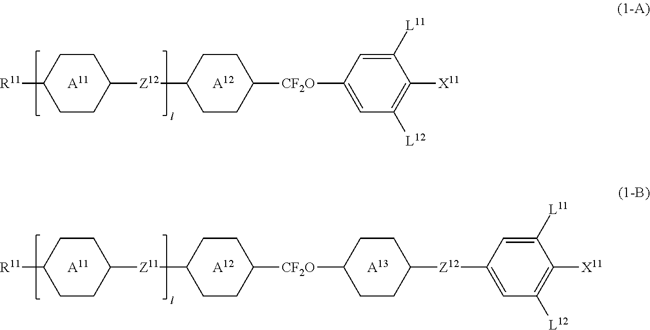
in Formula (1-A) or (1-B),
R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,
the ring A¹¹, the ring A¹² and the ring A¹³ are independently 1,4-phenylene or 1,4-cyclohexylene, and at least one hydrogen atom in these rings is optionally replaced with a halogen atom,
Z¹¹ and Z¹² are independently a single bond or an alkylene group having 1 to 4 carbon atoms, at least one —CH₂— in the alkylene group is optionally replaced with —O—, —S—, —COO—, —OCO—, —CH═CH—, —CF═CF— or —C≡C—, and at least one hydrogen atom in the alkylene group is optionally replaced with a halogen atom,
L¹¹ and L¹² are independently a hydrogen atom or a halogen atom,
X¹¹ is a halogen atom, —C≡N, —N═C═S, —CF₃ or —OCF₃, and 1 is 0, 1 or 2.

6. The material for a liquid crystal device according to claim 1,
wherein the liquid crystal material further comprises a compound represented by Formula (1-C): 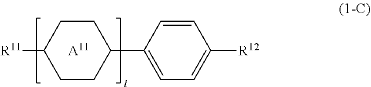
in Formula (1-C),
R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,
the ring A¹¹ is independently 1,4-phenylene or 1,4-cyclohexylene, and at least one hydrogen atom in these rings is optionally replaced with a halogen atom, and
l is 1, 2 or 3.

7. The material for a liquid crystal device according to claim 1,
wherein the liquid crystal material further comprises a compound represented by General Formula (1-E): 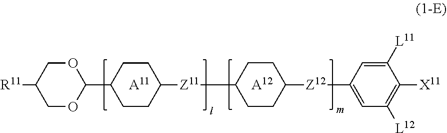
in General Formula (1-E), R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,
the ring A¹¹ and the ring A¹² are independently 1,4-phenylene or 1,4-cyclohexylene, and any hydrogen atom in these rings is optionally replaced with a halogen atom,
Z¹¹ and Z¹² are independently a single bond or an alkylene group having 1 to 4 carbon atoms, wherein any hydrogen atom in the alkylene group is optionally replaced with a halogen atom, and at least one —CH₂— in the alkylene group is optionally replaced with —O—, —S—, —COO—, —OCO—, —CF₂O—, —OCF₂—, —CH═CH—, —CF═CF— or —C≡C—,
L¹¹ and L¹² are independently a hydrogen atom or a halogen atom,
X¹¹ is a halogen atom, —C≡N, —N═C═S, —SF₅, —CF₃ or —OCF₃, and
l and m are independently 0 or 1.

8. A liquid crystal device comprising:
two substrates each having an electrode layer and at least one of the substrate is transparent; and
a light control layer that is supported between the substrates,
wherein the light control layer comprises a transparent material formed of a polymer of the polymerizable compound and the liquid crystal material having a chiral nematic phase according to claim 1.

9. The liquid crystal device according to claim 8,
wherein a content of the transparent material in the light control layer is in a range of 0.1 to 50 weight %.

10. A light control method comprising:
applying a voltage to a light control layer comprising a transparent material formed of a polymer of the polymerizable compound and the liquid crystal material having a chiral nematic phase according to claim 1, and driving the light control layer.

11. A light control method comprising:
providing two substrates each having an electrode layer and at least one of the substrate is transparent, and a light control layer that is supported between the substrates, and
incorporating the liquid crystal material comprising a transparent material formed of a polymer of the polymerizable compound and having a chiral nematic phase according to claim 1 into the light control layer, and
applying a voltage between electrodes and driving the light control layer.

12. A method of producing a liquid crystal device comprising:
interposing the material for a liquid crystal device according to claim 1 between two substrates each having an electrode layer and at least one of the substrate is transparent;
emitting ultraviolet rays or heating;
polymerizing the polymerizable compound; and
forming a light control layer formed of transparent material and liquid crystal material.

13. The material for a liquid crystal device according to claim 2,
wherein the liquid crystal material further comprises a compound represented by Formula (1-A) or (1-B): 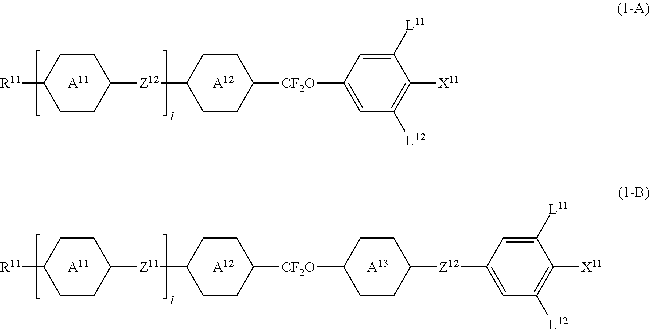
in Formula (1-A) or (1-B),
R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,
the ring A¹¹, the ring A¹² and the ring A¹³ are independently 1,4-phenylene or 1,4-cyclohexylene, and at least one hydrogen atom in these rings is optionally replaced with a halogen atom,
Z¹¹ and Z¹² are independently a single bond or an alkylene group having 1 to 4 carbon atoms, at least one —CH₂— in the alkylene group is optionally replaced with —O—, —S—, —COO—, —OCO—, —CH═CH—, —CF═CF— or —C≡C—, and at least one hydrogen atom in the alkylene group is optionally replaced with a halogen atom,
L¹¹ and L¹² are independently a hydrogen atom or a halogen atom,
X¹¹ is a halogen atom, —C≡N, —N═C═S, —CF₃ or —OCF₃, and 1 is 0, 1 or 2.

14. The material for a liquid crystal device according to claim 3,
wherein the liquid crystal material further comprises a compound represented by Formula (1-A) or (1-B): 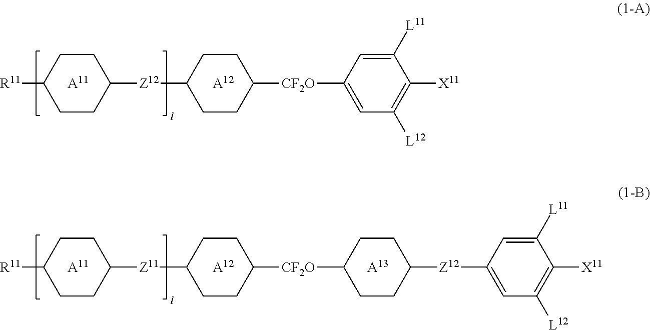
in Formula (1-A) or (1-B),
R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,
the ring A¹¹, the ring A¹² and the ring A¹³ are independently 1,4-phenylene or 1,4-cyclohexylene, and at least one hydrogen atom in these rings is optionally replaced with a halogen atom,
Z¹¹ and Z¹² are independently a single bond or an alkylene group having 1 to 4 carbon atoms, at least one —CH₂— in the alkylene group is optionally replaced with —O—, —S—, —COO—, —OCO—, —CH═CH—, —CF═CF— or —C≡C—, and at least one hydrogen atom in the alkylene group is optionally replaced with a halogen atom,
L¹¹ and L¹² are independently a hydrogen atom or a halogen atom,
X¹¹ is a halogen atom, —C≡N, —N═C═S, —CF₃ or —OCF₃, and 1 is 0, 1 or 2.

15. The material for a liquid crystal device according to claim 4,
wherein the liquid crystal material further comprises a compound represented by Formula (1-A) or (1-B): 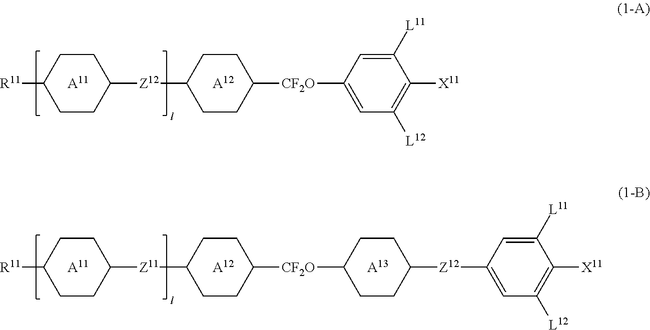
in Formula (1-A) or (1-B),
R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,
the ring A¹¹, the ring A¹² and the ring A¹³ are independently 1,4-phenylene or 1,4-cyclohexylene, and at least one hydrogen atom in these rings is optionally replaced with a halogen atom,
Z¹¹ and Z¹² are independently a single bond or an alkylene group having 1 to 4 carbon atoms, at least one —CH₂— in the alkylene group is optionally replaced with —O—, —S—, —COO—, —OCO—, —CH═CH—, —CF═CF— or —C≡C—, and at least one hydrogen atom in the alkylene group is optionally replaced with a halogen atom,
L¹¹ and L¹² are independently a hydrogen atom or a halogen atom,
X¹¹ is a halogen atom, —C≡N, —N═C═S, —CF₃ or —OCF₃, and 1 is 0, 1 or 2.

16. The material for a liquid crystal device according to claim 2,
wherein the liquid crystal material further comprises a compound represented by General Fornula (1-E): 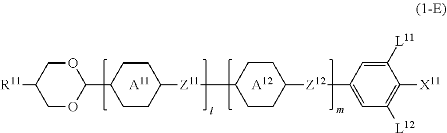
in General Formula (1-E), R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,
the ring A¹¹ and the ring A¹² are independently 1,4-phenylene or 1,4-cyclohexylene, and any hydrogen atom in these rings is optionally replaced with a halogen atom,
Z¹¹ and Z¹² are independently a single bond or an alkylene group having 1 to 4 carbon atoms, wherein any hydrogen atom in the alkylene group is optionally replaced with a halogen atom, and at least one —CH₂— in the alkylene group is optionally replaced with —O—, —S—, —COO—, —OCO—, —CF₂O—, —OCF₂—, —CH═CH—, —CF═CF— or —C≡C—,
L¹¹ and L¹² are independently a hydrogen atom or a halogen atom,
X¹¹ is a halogen atom, —C≡N, —N═C═S, —SF₅, —CF₃ or —OCF₃, and
l and m are independently 0 or 1.

17. The material for a liquid crystal device according to claim 3,
wherein the liquid crystal material further comprises a compound represented by General Formula (1-E): 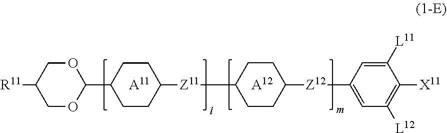
in General Formula (1-E), R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,
the ring A¹¹ and the ring A¹² are independently 1,4-phenylene or 1,4-cyclohexylene, and any hydrogen atom in these rings is optionally replaced with a halogen atom,
Z¹¹ and Z¹² are independently a single bond or an alkylene group having 1 to 4 carbon atoms, wherein any hydrogen atom in the alkylene group is optionally replaced with a halogen atom, and at least one —CH₂— in the alkylene group is optionally replaced with —O—, —S—, —COO—, —OCO—, —CF₂O—, —OCF₂—, —CH═CH—, —CF═CF— or —C≡C—,
L¹¹ and L¹² are independently a hydrogen atom or a halogen atom,
X¹¹ is a halogen atom, —C≡N, —N═C═S, —SF₅, —CF₃ or —OCF₃, and
l and m are independently 0 or 1.

18. The material for a liquid crystal device according to claim 4,
wherein the liquid crystal material further comprises a compound represented by General Formula (1-E): 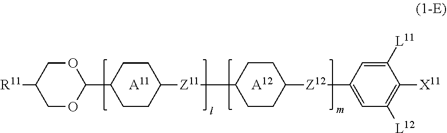
in General Fonnula (1-E), R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,
the ring A¹¹ and the ring A¹² are independently 1,4-phenylene or 1,4-cyclohexylene, and any hydrogen atom in these rings is optionally replaced with a halogen atom,
Z¹¹ and Z¹² are independently a single bond or an alkylene group having 1 to 4 carbon atoms, wherein any hydrogen atom in the alkylene group is optionally replaced with a halogen atom, and at least one —CH₂— in the alkylene group is optionally replaced with —O—, —S—, —COO—, —OCO—, —CF₂O—, —OCF₂—, —CH═CH—, —CF═CF— or —C≡C—,
L¹¹ and L¹² are independently a hydrogen atom or a halogen atom,
X¹¹ is a halogen atom, —C≡N, —N═C═S, —SF₅, —CF₃ or —OCF₃, and
l and m are independently 0 or 1.

19. The material for a liquid crystal device according to claim 5,
wherein the liquid crystal material further comprises a compound represented by General Formula (1-E): 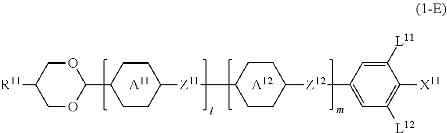
in General Formula (1-E), R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,
the ring A¹¹ and the ring A¹² are independently 1,4-phenylene or 1,4-cyclohexylene, and any hydrogen atom in these rings is optionally replaced with a halogen atom,
Z¹¹ and Z¹² are independently a single bond or an alkylene group having 1 to 4 carbon atoms, wherein any hydrogen atom in the alkylene group is optionally replaced with a halogen atom, and at least one —CH₂— in the alkylene group is optionally replaced with —O—, —S—, —COO—, —OCO—, —CF₂O—, —OCF₂—, —CH═CH—, —CF═CF— or —C≡C—,
L¹¹ and L¹² are independently a hydrogen atom or a halogen atom,
X¹¹ is a halogen atom, —C≡N, —N═C═S, —SF₅, —CF₃ or —OCF₃, and
l and m are independently 0 or 1.

20. The material for a liquid crystal device according to claim 5,
wherein the liquid crystal material further comprises a compound represented by Formula (1-C): 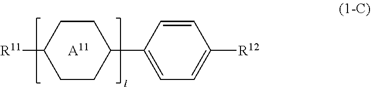
in Formula (1-C),
R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,
the ring A¹¹ is independently 1,4-phenylene or 1,4-cyclohexylene, and at least one hydrogen atom in these rings is optionally replaced with a halogen atom, and
l is 1, 2 or 3.

21. The material for a liquid crystal device according to claim 20,
wherein the liquid crystal material further comprises a compound represented by General Formula (1-E): 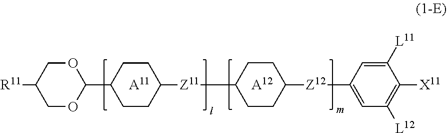
in General Formula (1-E), R¹¹ is a hydrogen atom, an alkyl group having 1 to 20 carbon atoms, at least one —CH₂— in the alkyl group is optionally replaced with —O—, —S—, —COO—, —OCO— or —CH═CH—, and at least one hydrogen atom in the alkyl group is optionally replaced with a halogen atom,
the ring A¹¹ and the ring A¹² are independently 1,4-phenylene or 1,4-cyclohexylene, and any hydrogen atom in these rings is optionally replaced with a halogen atom,
Z¹¹ and Z¹² are independently a single bond or an alkylene group having 1 to 4 carbon atoms, wherein any hydrogen atom in the alkylene group is optionally replaced with a halogen atom, and at least one —CH₂— in the alkylene group is optionally replaced with —O—, —S—, —COO—, —OCO—, —CF₂O—, —OCF₂—, —CH═CH—, —CF═CF— or —C≡C—,
L¹¹ and L¹² are independently a hydrogen atom or a halogen atom,
X¹¹ is a halogen atom, —C≡N, —N═C═S, —SF₅, —CF₃ or —OCF₃, and
l and m are independently 0 or 1.
